(19) United States
(12) Patent Application Publication
(10) Pub. No.: US 2026/0268211 A1
(43) Pub. Date: Sep. 10, 2026

(54) COMBINED SYSTEM AND METHOD FOR SELECTION, ANNOTATION AND TRAINING VIA A SHARED MACHINE-LEARNING MODEL

(71) Applicants: SURGAR, CLERMONT-FERRAND (FR); UNIVERSITÉ CLERMONT-AUVERGNE, CLERMONT-FERRAND (FR); CENTRE NATIONAL DE LA RECHERCHE SCIENTIFIQUE, Paris (FR); CLERMONT AUVERGNE INP, Aubière (FR)

(72) Inventors: Adrien BARTOLI, Clermont-Ferrand (FR); Ivan MIKHAILOV, Clermont-Ferrand (FR)

(73) Assignees: SURGAR, CLERMONT-FERRAND (FR); UNIVERSITÉ CLERMONT AUVERGNE, CLERMONT-FERRAND (FR); CENTRE NATIONAL DE LA RECHERCHE SCIENTIFIQUE, Paris (FR); CLERMONT AUVERGNE INP, Aubière (FR)

(21) Appl. No.: 19/163,831

(22) PCT Filed: Mar. 8, 2024
(86) PCT No.: PCT/EP2024/056148

§ 371 Date: Sep. 9, 2025

(30) Foreign Application Priority Data
Mar. 9, 2023 (FR) FR2302198

(51) Int. Cl. G06N 20/00; G06T 7/10; G06V 10/764; G06V 10/776; G06V 20/70

(52) U.S. Cl. CPC G06N 20/00; G06T 7/10; G06V 10/764; G06V 10/776; G06V 20/70; G06V 2201/07

(57) ABSTRACT

The invention relates to a combined system for selection and annotation of training data of a machine learning model, comprising the model (12) and two databases (14, 16) comprising respectively non-annotated or annotated data, characterized in that the model is configured to select a group of the most useful non-annotated data (20) to be annotated, to machine-annotate the most useful non-annotated data (20), to receive at least one annotation validation and/or correction of the data by an expert (18) in order to provide validated data (24) stored in the second database (16), and to be re-trained by the validated data of the second database (16) for the selection of the most useful non-annotated data and for the interactive annotation.

### TECHNICAL FIELD OF THE INVENTION

The invention relates to a combined system for selection of training data of a machine learning model, for annotation of training data of the model, for training the learning model and for prediction from the model, a method and an associated computer program product. The invention is intended in particular for the annotation of data linked to the segmentation of medical images, for example from magnetic resonance imaging (MRI) or computed tomography (CT) for the identification of organs in each of the sectional images obtained by MRI or CT in order to recreate 3D modeling of the organ from these segmentations, amongst other applications.

### TECHNOLOGICAL BACKGROUND

The segmentation of images is a technique making it possible to associate with each pixel or voxel of a 2D or 3D image a label which is representative of the object, of the texture or of the state, etc. corresponding to said pixel or voxel.

Image segmentation is used particularly in a medical context to determine the organs, tissues, fluids, etc. visible in a 2D or 3D image. Such an image is, for example, obtained by MRI and makes it possible to form a 3D model of the targeted organ and, for example, of its environment and of the tumor to be operated on. This creation of a 3D model necessitates the segmentation of the images which are obtained by MRI.

The segmentation of the images can be based on the use of a machine learning model enabling automatic or semi-automatic segmentation of the images, respectively with or without the aid of a user enabling corrections to be made. The machine learning model acts as a predictor which, receiving as input an image to be segmented, outputs a segmented image.

The use of a machine learning model necessitates prior training of the model using a large quantity of annotated data, i.e. images in which the different classes of segmentation have been determined and annotated/labelled. These annotated data are grouped into a dataset dedicated to the training, validation and testing of the implemented model.

The availability of the annotated data is an essential condition for the supervised training of the machine learning systems, which are defined by their capacity to learn from these annotated data in order to make predictions or to take decisions. At the heart of a machine learning system is the predictor which is formed by a machine learning model representing what has been learned by the system by virtue of the annotated data.

The performances and capacities for generalization of the supervised machine learning depend intrinsically on the size and composition of the group of annotated learning data. However, the annotation of the data is generally expensive: it often requires particular expertise in the target field, as well as particular attention to detail and precise inputting by the annotator. This is particularly true in the field of medical imaging, which requires deep medical knowledge and often presents difficulties in interpretation. This requirement for intervention by a specialist renders the increase in the size of the group of data more complex: the annotation of large quantities of data requires specialized staff and a considerable amount of time.

Solutions have been proposed to simplify the task of annotation in various ways.

In particular, solutions to alleviate the problem of the annotation of the data have been e.g. semi-supervised, weakly supervised, self-supervised and non-supervised learning, zero-shot and one-shot learning, transfer learning and multitask learning. They make it possible to limit or entirely remove the need for human annotation. However, they have limited applicability: they are error-sensitive, which makes them less suitable for complex, safety-critical and highly variable problems, typically such as the problems linked to clinical and medical applications. These solutions offer less control over the quality of the results, generally necessitate more complex algorithms and finer tuning, and can result in models which are less precise and harder to interpret than supervised learning. Supervised learning generally offers a simpler means of achieving better performance when sufficient annotated data are available, and thus remains relevant and is used in numerous current approaches. Thus the annotation of data by a human specialist remains useful and the search for a solution to accelerate the annotation process is relevant. The human specialist thus has the role of an expert for the machine learning system.

The basic machine learning paradigm comprises three principal phases: a data annotation phase, a training phase of the predictor machine learning model and an evaluation phase. The system can thus return to the data annotation phase if necessary. In the simplest systems, the data annotation phase can use a conventional annotation system such as 3D Slicer, which requires a considerable amount of effort and time for a human expert. In more advanced systems, this phase can be improved by using the selection of the most useful non-annotated data by active learning. This solution makes it possible to reduce the number of data to be annotated while allowing annotated data to be obtained which are relevant to the training of the machine learning model.

Some solutions propose the replacement of the conventional annotation system by a dedicated annotation predictor. The annotation predictor suggests annotation which the specialist can validate or correct. This raises the question of the training of this annotation predictor. The existing systems train the annotation predictor once a sufficient quantity of data has been annotated by the conventional annotation system. They are sub-optimal because the annotation predictor and the conventional annotation system do not improve as the data are being annotated. One objective is thus to utilize the data as they are being annotated in order to train the annotation predictor so as to improve the annotation mechanism itself.

Other solutions propose supplementing the training by virtue of self-training, making it possible to use pseudo-labels in order to automatically provide data labelled by the model for the training of the model itself. However, these pseudo-labelled data are not of the same annotation quality as training data having benefited from a correction or validation, e.g. with a conventional annotation system.

The inventors have thus sought for a solution to simplify the annotation task for the expert by improving the existing systems.

### Aims of the Invention

The invention aims to provide a system, a method and a computer program product for selection of training data of a machine learning model, for annotation of training data of the model, for training the model and for prediction from the model.

The invention also aims to provide, in at least one embodiment, a system making it possible to use a shared learning model in order to effect the selection of training data, and to assist an expert in the annotation of training data, while enabling the deployment of the shared model as a predictor at any time.

The invention also aims to provide, in at least one embodiment, a system, a method and a computer program product enabling image segmentation, the detection and recognition of objects, and/or image classification, more generally any type of task linked to image processing, medical or non-medical, or to viewing by computer, including, but not limited to, classification, categorization, segmentation, semantic segmentation, instance segmentation, detection of objects, location.

### DESCRIPTION OF THE INVENTION

In order to do this, the invention relates to a combined system for selection of training data of a machine learning model and annotation of training data of the model, comprising:
the model pre-trained with initial annotated training data,
a first database comprising a group of non-annotated data,
a second database configured for the storage of annotated data, characterized in that the model is configured to:
select, from among the group of the non-annotated data of the first database, a group of the most useful non-annotated data to be annotated via an active learning method,
machine-annotate the most useful non-annotated data to provide machine-annotated data,
receive, via an interactive annotation interface of the system associated with the machine learning model, at least one annotation validation and/or one correction of the machine-annotated data by an expert in order to provide validated data, said validated data being stored in the second database,
be re-trained by the validated data of the second database for the selection of the most useful non-annotated data and for the interactive annotation.

A combined system in accordance with the invention thus makes it possible to manage different functions around a shared learning model so that the learning model benefits from this interaction between the different functions.

In particular, the system makes it possible on the one hand to select the training data by determining which non-annotated data are the most useful for the training by virtue of the active learning implemented by the machine learning model. This makes it possible to reduce the number of data to be annotated by an expert and to enable continual addition of new data to be annotated by prioritizing the non-annotated data which make the greatest contribution to improving the performance of the system in the next training cycle.

The system also makes it possible to provide a solution enabling a human expert to be assisted in the interactive annotation of these most useful data by using this same machine learning model in order to simplify the annotation of the data. The annotation is thus controlled and guided by the machine learning model. The more effective the model, the lower the number of required interactions by the expert for the annotation of the data, in particular because the necessary number of corrections by the expert is reduced. The annotated data are also of better quality than the pseudo-labelled data resulting from self-training.

Finally, the annotated data are themselves used for the re-training of the model, in particular to assist in the sorting of the most useful non-annotated data to be annotated, and for assisting the expert in annotating the non-annotated data. The time spent in annotating the data is thus reduced for the expert, while retaining control of the annotation. The re-training broadly designates a number of solutions making it possible to train the model with the group of annotated data comprising the annotated data already used for the training and the validated data, which may consist of:
complete re-training,
fine tuning or continual learning.

This re-training is effected by machine or by a human specialist competent to act on the machine learning model.

The merging of these functions makes it possible on the one hand to limit the resources required for the annotation, and on the other hand to improve the overall performance of the annotation system, by combining the learning and annotation channels in a single combined system by the joint usage of the active learning by the machine learning model and of the interactive annotation using the same machine learning model as an annotation assistant. The use of a shared machine learning model thus also makes it possible to facilitate the management of the model and to reduce the technical and logistical times and interventions, in particular by combining the annotation phase and the training phase of the machine learning model.

This approach also makes it possible to facilitate the deployment of the machine learning model for its function of automatic prediction of annotations for the non-annotated data when the machine learning model is sufficiently trained, in particular when the dataset having been annotated by the expert is of sufficiently large size. The pre-training also makes it possible to rapidly approach a deployable system which acts as a predictor during the interactive annotation assisting the expert, while enabling the re-training with the new annotated data. Furthermore, the pre-training requires only a minimal number of initial annotated training data because the expert corrects the first predictions and the model is rapidly improved. Initial annotated data are also preserved as test data in order to follow the progression of the re-training.

Thus the system makes possible strong, two-way interaction between the annotation and the prediction: the selection of the data to be annotated is effected with the objective of achieving a better prediction of the machine learning model and the prediction by the learning model makes it possible to assist in the generation of the annotations of the non-annotated data. The active learning method selects the data based on specific criteria which may be internal to the datum, external to the datum (metadata), dependent on the data already annotated, and/or the complexity of annotation, etc.

The interactive annotation method is e.g. derived from prior art methods, e.g. a method derived from the methods described in one of the following publications:
Amrehn, M., Gaube, S., Unberath, M., Schebesch, F., Horz, T., Strumia, M., Steidl, S., Kowarschik, M., Maier, A., 2017. UI-Net: Interactive Artificial Neural Networks for Iterative Image Segmentation Based on a User Model, in: Eurographics Workshop on Visual Computing for Biology and Medicine, The Eurographics Association.
Zhou, T., Li, L., Bredell, G., Li, J., Konukoglu, E., 2021. Quality-aware memory network for interactive volumetric image segmentation, in: MICCAI.
Liao, X., Li, W., Xu, Q., Wang, X., Jin, B., Zhang, X., Zhang, Y., Wang, Y., 2020. Iteratively-refined interactive 3d medical image segmentation with multi-agent reinforcement learning. 2020 IEEE/CVF Conference on Computer Vision and Pattern Recognition (CVPR), 9391-9399.

The prior art systems use different means for the selection of data, their machine annotation and the validation/correction by the expert. Although some prior art systems are already using machine learning models in each step of the training, none of these prior art systems combine the selection of data, their machine annotation and the validation/correction by the expert for the training of a single model. The prior art systems generally use a model which is already fully trained in at least one of the steps, in particular for the annotation tool, and this already fully trained model has not benefited from the improvements in data which the other functions would have provided within the scope of the invention.

For example, the annotation of data is generally effected by pre-trained tools, based on a machine or non-machine learning model. The prior art machine learning models use an active learning method independently of the annotation mechanism. Whilst active learning is effected, it is not used to improve the machine learning model which is used for the machine annotation and the interactive annotation.

Advantageously and in accordance with the invention, the selection of the group of the most useful non-annotated data to be annotated is effected via the machine learning model using one or more of the following selection criteria:
one or more internal properties of the datum,
one or more external properties of the datum,
the uncertainty of prediction by the machine learning model,
the representativeness of the annotated data and of the non-annotated data,
a criterion of difficulty of annotation of the data.

Advantageously and in accordance with the invention, the system is configured for the annotation of new non-annotated data for at least one of the following applications:
segmentation of new non-segmented or partially segmented images,
detection and recognition of objects in new images,
classification of new images,
categorization of new images.

According to this aspect of the invention, the system is deployed for its final task and makes possible the annotation of new data not having been used for the training, i.e. not having been used for the pre-training or re-training.

According to other variants of the invention, the system is used in other applications, in particular any type of task linked to image processing, medical or non-medical, or to viewing by computer, including, but not limited to, classification, categorization, segmentation, semantic segmentation, instance segmentation, detection of objects, location, etc.

The invention also relates to a method for selection of training data of a machine learning model and annotation of training data of the model, said model being pre-trained with initial annotated training data, comprising:
a step of selection, by the machine learning model and from among the group of non-annotated data, of a group of the most useful non-annotated data to be annotated via an active learning method,
a step of machine annotation by the machine learning model of the most useful non-annotated data in order to provide machine-annotated data,
a step of receiving at least one annotation correction and/or validation of the machine-annotated data by an expert in order to provide validated data,
a step of training the machine learning model by the validated data for the selection of the most useful non-annotated data and for the interactive annotation.

Advantageously, the combined method in accordance with the invention is configured to be implemented by a combined system in accordance with the invention.

Advantageously, the combined system in accordance with the invention is configured to implement the combined method in accordance with the invention.

The invention also relates to a combined computer program product for selection of training data of a machine learning model and annotation of training data of the model, said computer program product comprising program code instructions for executing, when said computer program product is being executed on a computer, the steps of the combined method in accordance with the invention.

The invention also relates to a combined system, a combined method and a combined computer program product, which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of a combined system for selection of training data of a machine learning model and annotation of training data of the model according to one embodiment of the invention.

FIG. 2 is a schematic view of a combined method for selection of training data of a machine learning model and annotation of training data of the model according to one embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

In the figures, the machine learning model is shown with a symbol representing a neural network for illustrative purposes but other types of machine learning model can be used.

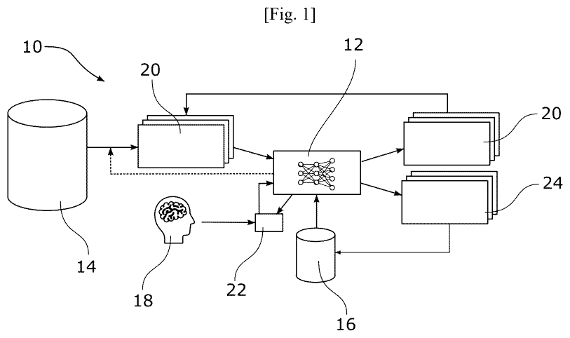

FIG. 1 schematically illustrates a combined system 10 for selection of training data of a machine learning model 12 and annotation of training data of the machine learning model 12 according to one embodiment of the invention. The system 10 comprises the machine learning model 12 and two databases making it possible to manage non-annotated data and annotated data, in particular a first database 14 comprising a group of non-annotated data and a second database 16 comprising a group of annotated data. The machine learning model 12 is pre-trained with initial annotated training data. Initial test data are also provided to test the performance of the system after the pre-training and each future instance of training.

In particular the system was tested on four datasets:
MRI segmentation of the female pelvis on a dataset created by the applicant comprising ninety-seven MRI series representing three thousand and sixty-six sections in total;
CT-type segmentation of the liver and of the pancreas on the “Medical Segmentation Decathlon” datasets, described in the publication “Simpson, A. L., Antonelli, M., Bakas, S., Bilello, M., Farahani, K., Ginneken, B. V., Kopp-Schneider, A., Landman, B. A., Litjens, G. J., Menze, B. H., Ronneberger, O., Summers, R. M., Bilic, P., Christ, P. F., Do, R. K., Gollub, M. J., Golia-Pernicka, J., Heckers, S., Jarnagin, W. R., McHugo, M., Napel, S., Vorontsov, E., Maier-Hein, L., & Cardoso, M. J. (2019). A large annotated medical image dataset for the development and evaluation of segmentation algorithms. ArXiv, abs/1902.09063.”: “Liver tumors” and “Pancreas tumors”;
MRI segmentation of the kidney on the AMOS dataset described in the publication: Yuanfeng, Ji & Bai, Haotian & Yang, Jie & Ge, Chongjian & Zhu, Ye & Zhang, Ruimao & Li, Zhen & Zhang, Lingyan & Ma, Wanling & Wan, Xiang & Luo, Ping. (2022). AMOS: A Large-Scale Abdominal Multi-Organ Benchmark for Versatile Medical Image Segmentation. 10.48550/arXiv.2206.08023.

The model can be pre-trained on respectively 12% (fifteen data volumes out of ninety-seven), 11% (fifteen data volumes out of one hundred and thirty-one), 12% (thirty-three volumes out of two hundred and eighty-two) and 3.3% (forty volumes out of one thousand three hundred) of all the data in order to be able to effectively produce quality annotations for the rest of the data using the system.

The machine learning model 12 is e.g. a neural network, e.g. an existing encoder-decoder neural network architecture, e.g. a ResNet34 encoder described in the publication “He, K., Zhang, X., Ren, S., Sun, J., 2016. Deep residual learning for image recognition. 2016 IEEE Conference on Computer Vision and Pattern Recognition (CVPR), 770-778.” and a generic decoder.

The system 10, when deployed, is able to predict, by machine, an annotation of the non-annotated data, permitting a correction or verification by an expert 18, who is a human user sufficiently competent to carry out this correction or verification, in other words a human specialist. The correction or verification by the expert is important in particular in the medical context where the annotation of the non-annotated data presents a challenge for a future therapeutic or surgical intervention, e.g. for a segmentation of medical images intended for the generation of 3D models of organs to assist in augmented reality-assisted surgery.

Following the pre-training, the machine learning model 12 requires re-training in order to improve its performance. This training requires data which must be annotated by the human expert 18.

The first database 14 can comprise a large number of non-annotated data. The non-annotated data are sorted in order to obtain a group 20 of the most useful non-annotated data, thus making it possible to reduce the time required for the human expert 18 to generate annotated training data.

The learning model 12 thus comprises as inputs the group of the most useful non-annotated data and interactions from the human expert 18 for the annotation of the non-annotated data. In particular, the human expert 18 has access to a user interaction loop 22 connected by the machine learning model 12. The interaction loop 22 receives data machine-annotated by the machine learning model 12. The user interaction loop 22 makes it possible to take into account a correction and/or validation by the human expert 18 of these annotated data via a user interface of the interaction loop 22. The machine learning model 12 takes into account the possible corrections and proposes a new machine annotation as a result.

The user of the machine learning model 12 as an annotation assistant is a method which may be termed interactive annotation.

A machine learning model system comprising such an interaction loop for taking the annotations into account is described e.g. in the publication of the inventors of the present application: Mikhailov, I., Chauveau, B., Bourdel, N., Bartoli, A. (2022). A Deep Learning-Based Interactive Medical Image Segmentation Framework. In: Wu, S., Shabestari, B., Xing, L. (eds) Applications of Medical Artificial Intelligence. AMAI 2022. Lecture Notes in Computer Science, vol 13540. Springer, Cham.

Once the annotation has been validated by the human expert 18, the machine learning model 12 outputs validated data 24 which are stored in the second database 16. The new annotated data added to the second database 16 thus make it possible to re-train the machine learning model 12.

Apart from its machine annotation functions, the machine learning model 12 is itself configured to output the most useful data 20 to annotate, which will be used as input to be annotated. This method is termed active learning.

An active learning method able to be used is e.g. a method based on the selection of data based on uncertainty via calculation of entropy. This method is based, in particular, on the principle that a prediction having a high level of entropy linked to an uncertain prediction is representative of a datum which is informative and useful for the training of the model.

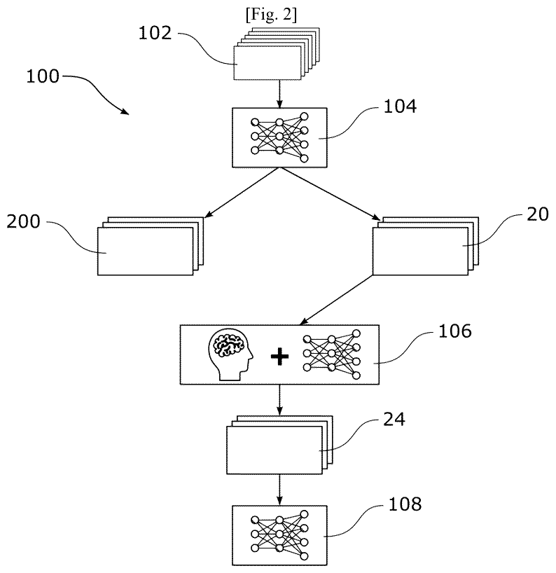

FIG. 2 schematically illustrates a combined method 100 for selection of training data of a machine learning model and annotation of training data of the model according to one embodiment of the invention.

The method 100 represents a data selection and data annotation iteration able to be implemented by a system as described in reference to FIG. 1. In practice, the method can be implemented iteratively for the annotation of non-annotated data until it stops or when the group of non-annotated data have been annotated. Each iteration terminates by a re-training of the machine learning model from a training set comprising the new annotated data. The stopping of the iterations can be effected in particular when the tests carried out with the test data give an error rate below a certain threshold, or when a human specialist, e.g. the expert, considers that the performance of the annotation by the machine learning model is sufficient. The method 100 comprises a step 104 of selection, by the machine learning model and from among the group of non-annotated data 102, of a group 20 of the most useful non-annotated data via an active learning method, The data 200 considered to be less useful are ignored and not annotated in this iteration.

The determination of the most useful data 20 is effected by inference from the machine learning model and is based on criteria of usefulness which may be:
linked to the internal properties of the datum, e.g. the type of datum or the quality of the datum or an intrinsic value of the datum (value of a field, value of a pixel or of a pixel zone, etc.);
linked to the external properties of the datum, of the metadata type, e.g. the origin of the datum, etc.;
linked to the uncertainty of prediction because the data for which the predictor gives results with the greatest uncertainty generally indicate that these data are the most informative;
linked to representativeness, the selection of data with a unique characteristic being more informative; or personalized criteria, e.g. a combination of these criteria or of other criteria.

The method 100 then comprises a step 106 of interactive annotation, comprising in particular a step of machine annotation by the machine learning model of the most useful non-annotated data 20 in order to provide machine-annotated data, and a step of receiving at least one annotation correction and/or validation of the machine-annotated data by an expert in order to provide validated data 24 which are annotated data and the annotation of which has been validated by the human expert.

Finally, the method comprises a step 108 of training the machine learning model by the validated data 24 for the selection of the most useful non-annotated data and for the interactive annotation. The machine learning model is thus improved for the following iteration, and the model is thus re-trained in each iteration. The number of annotated data having been used for the training is thus increased in each iteration, ensuring that the most useful data are annotated in order to optimize the annotation time by the expert and to increase the performance of the machine learning model. Furthermore, the selection of data maximizes the impact of each annotation on the performance of the machine learning model, which makes possible a rapid improvement in the performance of the machine learning model.

The system and the method can in particular be used for the segmentation of medical images. In this context, the criteria for selection of the most useful data can be e.g.:
linked to the internal properties of the datum, e.g. the type of image or the quality of the image;
linked to the external properties of the datum, of the metadata type, e.g. a selection according to the age or gender of the patient from whom the data originate, the source of the datum, etc.;
linked to the uncertainty of prediction by an inference of the machine learning model on all the non-annotated data;
linked to the representativeness, e.g. the images with one characteristic which is at a position remote from the average;
or personalized criteria, e.g. a pre-selection of data considered the most difficult to annotate by a human expert.

The invention can also be used in other contexts than image segmentation, in particular, the detection and recognition of objects, and/or image classification, more generally any type of task linked to image processing, medical or non-medical, or to viewing by computer, including, but not limited to, classification, categorization, segmentation, semantic segmentation, instance segmentation, detection of objects, location.

1. A combined system for selection of training data of a machine learning model and annotation of training data of the model, comprising:
a machine learning model pre-trained with initial annotated training data,
a first database comprising a group of non-annotated data,
a second database configured for the storage of annotated data, wherein the machine learning model is configured to:
select, from among the group of the non-annotated data of the first database, a group of the most useful non-annotated data to be annotated via an active learning method,
machine-annotate the most useful non-annotated data to provide machine-annotated data,
receive, via an interactive annotation interface of the system associated with the machine learning model, at least one annotation validation and/or one correction of the machine-annotated data by an expert in order to provide validated data, said validated data being stored in the second database,
be re-trained by the validated data of the second database for the selection of the most useful non-annotated data and for the interactive annotation.

2. The combined system as claimed in claim 1, wherein the selection of the group of the most useful non-annotated data to be annotated is effected via the machine learning model using one or more of the following selection criteria:
one or more internal properties of the datum,
one or more external properties of the datum,
the uncertainty of prediction by the machine learning model,
the representativeness of the annotated data and of the non-annotated data,
a criterion of difficulty of annotation of the data.

3. The combined system as claimed in claim 1, wherein the system is configured for the annotation of new non-annotated data for at least one of the following applications:
segmentation of new non-segmented or partially segmented images,
detection and recognition of objects in new images,
classification of new images,
categorization of new images.

4. A method for selection of training data of a machine learning model and annotation of training data of the machine learning model, said machine learning model being pre-trained with initial annotated training data, the method comprising:
a step of selection, by the machine learning model and from among the group of non-annotated data, of a group of the most useful non-annotated data to be annotated via an active learning method, a step of machine annotation by the machine learning model of the most useful non-annotated data in order to provide machine-annotated data,
a step of receiving at least one annotation correction and/or validation of the machine-annotated data by an expert in order to provide validated data,
a step of training the machine learning model by the validated data for the selection of the most useful non-annotated data and for the interactive annotation.

5. The method as claimed in claim 4, wherein the selection of the group of the most useful non-annotated data to be annotated is effected via the machine learning model using one or more of the following selection criteria:
one or more internal properties of the datum,
one or more external properties of the datum,
the uncertainty of prediction by the machine learning model,
the representativeness of the annotated data and of the non-annotated data,
a criterion of difficulty of annotation of the data.

6. A combined computer program product for selection of training data of a machine learning model and annotation of training data of the machine learning model, said computer program product comprising program code instructions for executing, when said computer program product is being executed on a computer, the steps comprising:
a step of selection, by the machine learning model and from among the group of non-annotated data, of a group of the most useful non-annotated data to be annotated via an active learning method,
a step of machine annotation by the machine learning model of the most useful non-annotated data in order to provide machine-annotated data,
a step of receiving at least one annotation correction and/or validation of the machine-annotated data by an expert in order to provide validated data,
a step of training the machine learning model by the validated data for the selection of the most useful non-annotated data and for the interactive annotation.
